(19) United States
(12) Patent Application Publication
(10) Pub. No.: US 2008/0162512 A1
(43) Pub. Date: Jul. 3, 2008

(54) Efficient storage and distribution system for non-transactional data

(76) Inventor: Sanjeet Mall, Heidelberg (DE)

Correspondence Address: BRAKE HUGHES BELLERMANN LLP, C/O INTELLEVATE, P.O. BOX 52050, MINNEAPOLIS, MN, 55402, US

(21) Appl. No.: 11/648,121

(22) Filed: Dec. 29, 2006

(51) Int. Cl. G06F 17/30

(52) U.S. Cl. 707/100

(57) ABSTRACT

A method includes maintaining a database that includes a physical schema that includes a plurality of tables. The tables include table definitions and are populated with data that is modifiable independent of the table definitions. A table of the database that includes non-transactional data is identified, and a storage view of at least a subset of non-transactional data of the identified table is defined, where the storage view includes a storage view definition that includes the non-transactional data and where a modification of the non-transactional data that populates the storage view depends on modifying the storage view definition. Finally, the table in the physical schema is replaced with the storage view.

### TECHNICAL FIELD

This description relates to the storage and distribution of data.

### BACKGROUND

As technology improves and plays an even more central role in our lives, databases are required to store, process, and distribute ever increasing amounts of information. These heightened storage and distribution requirements placed upon databases may in turn consume ever increasing amounts of resources, such as processing power, time, and memory. Thus, any efficiencies that may be introduced, to or inefficiencies that may be removed, from the management of data in databases may in turn allow the databases to process larger amounts of information without consuming more processing resources.

Databases use one or more database objects to store the information of the databases, and central among these objects are tables. Tables are often used to store database data, because tables are flexible objects that may allow the data stored within them to be readily modified or updated, as often may be the case with database data. However, there may be various properties associated with, or forms of, database data, for example, in which certain data generally is not modified as frequently as other data, or in some cases there may exist data in a database that never changes. This more static data too may be stored in the flexible tables of databases even though the added flexibility may not be necessary for the more static data and may require greater overhead than storage of the data in other formats.

### SUMMARY

In a first general aspect, a method includes maintaining a database that includes a physical schema that includes a plurality of tables. The tables include table definitions and are populated with data that is modifiable independent of the table definitions. A table of the database that includes non-transactional data is identified, and a storage view of at least a subset of non-transactional data of the identified table is defined, where the storage view includes a storage view definition that includes the non-transactional data and where a modification of the non-transactional data that populates the storage view depends on modifying the storage view definition. Finally, the table in the physical schema is replaced with the storage view.

Implementations can include one or more of the following features. For example, the database can be a relational database. The physical schema can include a data model of how the data is to be represented in the database. The physical schema can include the data stored in the database. The plurality of tables can include tables having data organized into a definite number of columns and a variable number of rows. The table-definitions can include types of data or descriptions of the data included in the tables. The data can include transactional data and non-transactional data.

In another example implementation, identifying the table can include: determining a first overhead associated with maintaining and defining a test storage view including test data over a period of time; determining a second overhead associated with maintaining and modifying a test table including the test data over the period of time; determining a frequency associated with a number of times the test data may be modified in the test storage view and the test table over the period of time, where the first overhead is less than or equal to the second overhead; and identifying the table of the database that includes the non-transactional data, where the non-transactional data is associated with an anticipated number of modifications less than or equal to the frequency.

In other example implementations, replacing the table can include generating a view associated with the table and associating the view with the storage view. Defining the storage view can include copying the non-transactional data from the table into the storage view, where the view-definition includes the non-transactional data, and removing the table from the database. A modification associated with the non-transactional data in the storage view can be determined, and the view-definition can be re-defined to include the non-transactional data as modified based on the modification.

In another general aspect, a system includes a computer-readable storage medium and a database processor. The computer-readable storage medium is adapted for storing table data and a storage view. The storage table data populate a table based on a table definition, where the table data can be modified independently of the table definition. The storage view includes a storage view definition that includes a selection of the data extracted from the table, where the selection of data, as stored in the storage view, is modifiable independently of the table data, where upon a modification of the table data the storage view data and the table definition remain unchanged, and where a modification to the storage view requires a modification to the storage view definition. The database processor is configured to provide the selection of data to via the storage view to a client of the system.

Implementations can include one or more of the following features. For example, the data can include non-transactional data anticipated to remain constant. The database processor can be configured to prevent the client from modifying the storage view definition. The table definition can include a plurality of columns, where each column is associated with a column name and a data type corresponding to data stored in the table. The extracted selection of data can be removed from the table. The table can be removed after the data is extracted.

In another general aspect, a system includes a processor, a comparator, a database processor, and a computer-readable storage medium adapted for storing a database. The database includes tables of transactional data that include table definitions, where the transactional data is modifiable independent of the table definitions and storage views of non-transactional data that include storage view definitions, where a modification of the non-transactional data requires a modification of a view definition. The processor is adapted for executing an application to read data from the tables and the storage views and to write data to the tables. The comparator is configured to determine that data provided by the application, to be written to the database, includes non-transactional data to be stored in a first storage view. The database processor is configured to define the first storage view to include the data provided by the application in the view definition associated with the first storage view.

Implementations can include one or more of the following features. For example, the database can include a view associated with one or more of the tables, where a modification of the transactional data in the one or more tables modifies the transactional data as represented in the view. One or more of the tables can include non-transactional data.

The details of one or more implementations are set forth in the accompanying drawings and the description below. Other features will be apparent from the description and drawings, and from the claims.

### BRIEF DESCRIPTION OF THE DRAWINGS

FIG. 1 is a block diagram of an example system 100 that provides an efficient storage and distribution mechanism for non-transactional data according to an example embodiment.

FIG. 2 is a block diagram of another example system 200 that provides an efficient storage and distribution mechanism for non-transactional data according to an example embodiment.

FIG. 3 is a flowchart illustrating example operations of the system of FIGS. 1 and 2.

FIG. 4 is a graph 400 illustrating an example process for determining whether a storage view or a table should be used to store certain data in a database.

### DETAILED DESCRIPTION

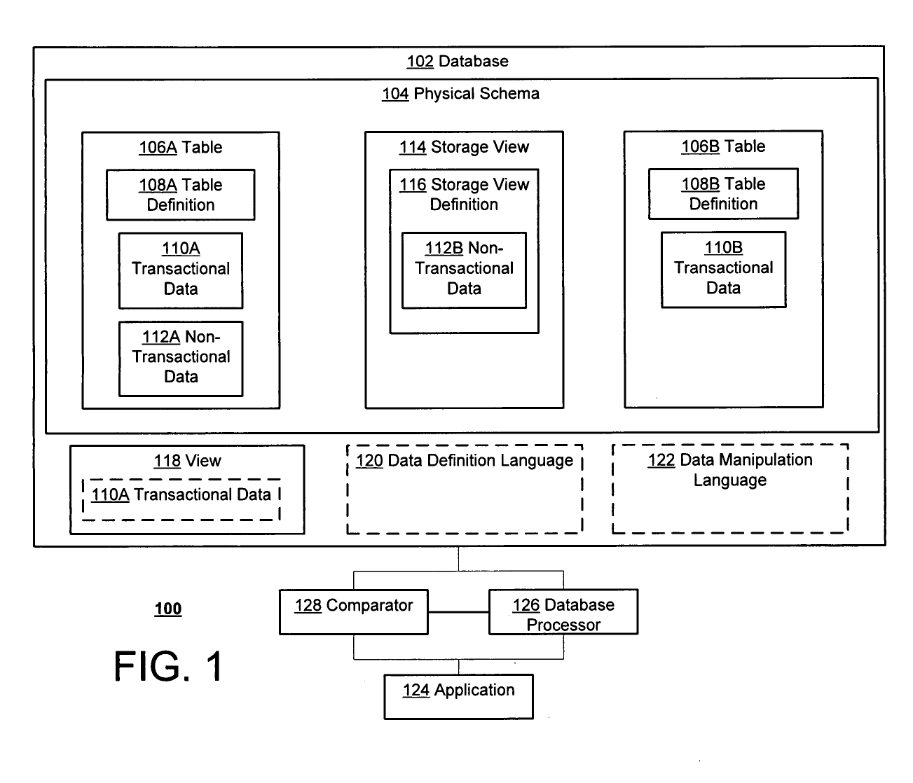

FIG. 1 is a block diagram of an example system 100 that provides an efficient storage and distribution mechanism for non-transactional data according to an example embodiment.

The system 100 includes a database 102 that may store both transactional and non-transactional data in tables and/or storage views. Use of tables for storing data may require extra memory resource overhead associated with creating and populating the tables and may increase inefficiencies associated with distributing the data of the tables to a user. However, the processing resources required for maintaining the tables may allow the data of the tables to be readily modifiable by the user without altering the table definitions or re-populating the tables with data, i.e., requiring minimal processing overhead. Thus, the tables may be best suited for storing transactional data that is modified frequently by the user or by another system associated with the database, thus making the extra memory resource overhead associated with creating and populating the tables cost efficient.

Use of storage views for storing data may require only minimal memory resource overhead, when compared to that of tables. This minimal memory resource overhead may then allow for the efficient distribution of data from storage views to users. However, the processing resources required for maintaining the storage views may be greater than that required to maintain the tables. Thus, the storage views may be best suited for storing non-transactional data that is anticipated to remain constant, thus making the extra processing overhead associated with the storage views cost efficient with respect to the minimal memory resource overhead associated with creating and, populating the storage views.

The database 102 may include a collection of data or records stored in a systematic way, allowing the records to be retrieved in response to queries presented to the database 102. The database 102 may include, for example, a commercially available and/or proprietary database or database management system including, but not limited to, Oracle™, MySQL™, and Microsoft Access™.

The database 102 may include or be associated with a physical schema 104 that may include data stored in the database 102. For example, the physical schema 104 may include one or more database servers including a plurality of database objects storing the data and sharing one or more interrelations or dependencies among the data. An example interrelation or dependency may include a one-to-one relation between names and addresses in that each name may be associated with only one address and vice versa. Then for example, selecting a first name may be associated with selecting a first address corresponding to the first name, selecting a different name may then signify selecting a different address.

The physical schema 104 may also be organized into a data model, such as, for example, a relational model, a hierarchical model, a network model, an object-oriented model, or any other data model. For example, in a relational model, the physical schema 104 may include rows of data, known as tuples, stored in one or more relations or tables 106A and 106B.

The tables 106A and 106B may include data of the database 102 stored in a system of horizontal rows and vertical columns. Each row, for example, may include a record or a tuple of the database 102. The tables 106A and 106B may include a variable number of rows that may be dependent on the quantity and/or characteristics of the data of the database 102. For example, if data is added to the database 102 then the number of rows may correspondingly increase.

The tables 106A and 106B may also include a fixed number of columns as specified by table definitions 108A and 108B, respectively. For example, the table definition 108A may include a plurality of fields associated with the data to be stored in the table 106A. For example, the plurality of fields in the table definition 108A may include one or more column descriptions, a data type associated with the column descriptions, a primary key indicating a value that can be used to identify a unique row in the table, and multiple fields used to track transaction information about the data in the table. According to an example embodiment, the plurality of fields of the table definition 108A may include a “last name” column with a data type of “30 characters or less.” Then for example, the table 106A may be populated with data corresponding to the table definition 108A such as “Smith,” “Robinson” and “Doe.”

The extra memory resource overhead associated with tables 106A and 106B, as discussed above, may arise at least in part from the plurality of fields created in the table definitions 108A and 108B. The data may be stored in the tables 106A and 106B separate from the table definitions 108A and 108B, which may reduce the processing overhead associated with maintaining the tables 108A and 108B, i.e. modifying the data.

The database 102 may include both transactional data 110A and 110B and non-transactional data 112A. The transactional data 110A and 110B may include data that is anticipated to undergo frequent modification. For example, the transactional data 110A may include exchange rates on the world's currencies, which may change every day, every minute, or even every second. In another example embodiment, the transactional data 110B may include a shopping cart associated with a website that provides a user the ability to add to and remove from the shopping cart, items sold on the website.

The non-transactional data 112A and 112B may include data that is anticipated to remain constant for some period of time. For example, the non-transactional data 112A may be determined to remain static relative to the frequency of change of the transactional data 110A. For example, the non-transactional data 112A may include the currencies of the world, i.e., a listing of which countries use which currencies. As such, while the non-transactional data 112A may change from time to time, for example when many countries in Europe began using the Euro in lieu of their former national currencies, the non-transactional data 112A is anticipated to remain relatively static. In other example embodiments, the non-transactional data 112B may include the fifty United States, the twelve months of the year, or a list of teams in a sports league.

A storage view 114 may include an object of the database 102 configured to store the non-transactional data 121B and/or the transactional data 110A and 110B. However, at least for the reasons discussed above including the minimal memory resource overhead associated with creating and distributing data from the storage view 114 and the extra processing overhead associated with maintaining the data in the storage view 114, the storage view 114 may be better suited for storing the non-transactional data 112A or 112B.

A storage view definition 116 may include the data determined to populate the storage view 114. This may be in contrast for example, to the table definition 108A that may include field information about the data to populate the table 106A. For example, the storage view definition 116 may include “Virginia,” “New York” and “California,” rather than fields about what data is going to populate the storage view 114. As a result, the non-transactional data 112B may need to be known at the definition time, i.e. at the time the storage view definition 116 is being defined. Then, for example, because the non-transactional data 121B is included in the storage view definition 116, the data of storage view 114 may be modified only by modifying the storage view definition 116; this may account for the extra processing overhead associated with the storage view 114.

Unlike the storage view 114 and the tables 106A and 106B that may include data and that may exist on the physical schema 104 of the database 102, the database 102 may also include a view 118 that may not be part of the physical schema 104. The view 118 may provide data that may not exist on the physical schema 104 and that may not even be determined until runtime. For example, the view 118 may include data pulled from one or more database objects, including the tables 106A and 106B and the storage view 114. However, rather than being populated with the data, the view 118 may include in its definition, a pointer to the data within the database object. For example, the view 118 may provide the transactional data 110A from the table 106A as determined during run-time, wherein a modification to the transactional data 110A of the table 106A would be reflected in the view 118.

In another example embodiment, the view 118 may include data pulled from the storage view 114 and the table 106B, wherein a calculation may be performed on the pulled data. For example, the view 118 may average the values of the pulled data and then provide the averaged value, thus providing data that may not exist on the physical schema 104. According to other example embodiments, the view 118 may include a subset of data from a database object, join data from several database objects, and/or perform one or more calculations on the data.

The data definition language 120 may be used to create or define database objects. For example, the data definition language 120 may be used to define the table definitions 108A and 108B and the storage view definition 116. As discussed above, the table definitions 108A and 108B may include information about the data populated in the tables 106A and 106B, and the storage view definition 116 may include the data populating the storage view 114.

The data manipulation language 122 may be used to update or modify data existing in selected pre-defined database objects without the need to redefine the database objects. For example, the data manipulation language 122 may be used to modify the transactional data 110A and the non-transactional data 112A of the table 106A without changing the table definition 108A. Then, for example, the data manipulation language 122 may not be used to modify the non-transactional data 112B of the storage view 114 for at least the reasons discussed above, including that the non-transactional data 112B is included in the storage view definition 116.

An application 124 may include a program or application configured to query, write to and/or receive data from the database 102. For example, the database 102 may provide to the application 124, data stored in the tables 106A and 106B and the storage view 114. For example, the database 102 may store data associated with a website offering items for sale. Then, for example, the application 102 may include an Internet browser configured to navigate the website, whereby a user may browse through the selection of items offered for sale as provided by the database 102, add and remove items from a shopping cart, and purchase items.

A database processor 126 may interface with the application 124 and the database 102. The database processor 126 may be configured to retrieve data from the database 102 and provide it to the application 124 and/or receive data from the application 124 and write it to the database 102. For example, continuing the website example above, a user of the application 124 may submit a request to view a selection of the items offered for sale, and then the database processor 126 may retrieve the data from the database 102 and provide the data to the application 124. Then, for example, the user may add an item to the user's shopping cart, and the database processor 126 may update or modify the record associated with the user's shopping cart to reflect the added item.

A comparator 128 may determine whether data provided by the application 124 may be written to the database 102. For example, a user of the application 124 may attempt to update the non-transactional data 112B of the storage view 114, according to an example embodiment. The non-transactional data 112B may include various currencies or forms of payment accepted by a website associated with the database 102. Then, for example, a manager of the website, using the application 124, may wish to modify the website so that it accepts payments in Euros. The request to add the Euro as a valid currency may be received by the comparator 128. The comparator 128 may then determine that data provided by the application 124 includes non-transactional data to be stored in the storage view 114. Upon the making of the determination by the comparator 128, the database processor 126 may use the data definition language 120 to redefine the storage view definition 116 of the storage view 114 to include the Euro. In another example embodiment, the database processor 126 may define a new storage view, rather than updating the definition of an existing storage view 114.

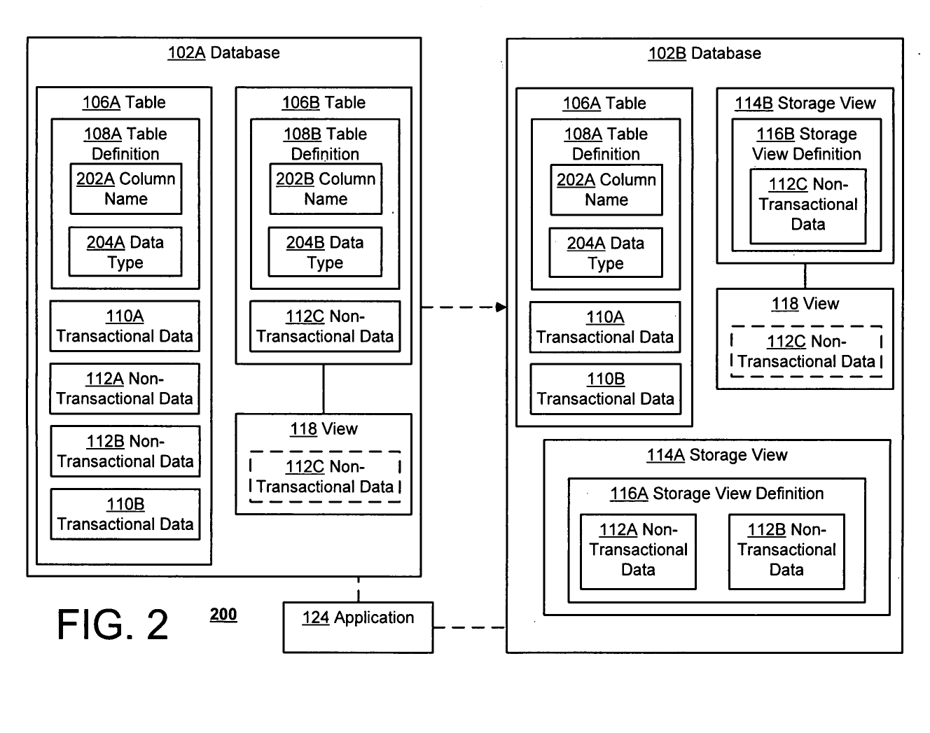

FIG. 2 is a block diagram of another example system 200 that provides an efficient storage and distribution mechanism for non-transactional data according to an example embodiment.

In the example of FIG. 2, the system 200 may include components that are similar or substantially similar to like numbered components of FIG. 1.

The database 102A may include the tables 106A and 106B, including the table definitions 108A and 108B. The tables 106A and 106B may include the transactional data 110A and 110B and/or the non-transactional data 112A, 112B, and 112C.

Column names 202A and 202B, included in the table definitions 108A and 108B, may include descriptions or names of column of the tables 106A and 106B. For example, the column name 202A may be “last name” for a column that is configured to store the last name of an individual. The table definition 108A may include a plurality of column names 202A associated with a plurality of columns of the table 106A.

Data types 204A and 204B may include a description or constraint on the type of data to be stored in columns of the tables 106A and 106B. For example, the data type 204A may include that the column associated with the column name 202A may be a character string of length 30 characters or less. In another example embodiment, the data type 204B may include that the column associated with the column name 202B may only be an integer data type.

The table 106A may then for example, be populated with the transactional data 110A and 110B and the non-transactional data 112A and 112B in accordance with the table definition 108A. The table 106B may be populated with the non-transactional data 112C in accordance with its table definition 108B. Then, for example, the view 118 may point to a selection of the non-transactional data 112C of the table 106B.

As discussed above, to reduce the inefficiencies associated with the storage and distribution of the non-transactional data 112A, 112B, and 112C from the tables 106A, 106B to and from the application 124, the non-transactional data 112A, 112B, and 112C, in whole or in part, may be stored in one or more storage views 114A and 114B as shown in the database 102B. The database 102B reflects an example embodiment, wherein at least a portion of the non-transactional data 112A, 112B, and 112C of the database 102A has been identified and removed from the tables 106A and 106B and stored in the storage views 114A and 114B.

In the database 102B the non-transactional data 112A and 112B was removed from the table 106A and stored in the storage view definition 116A of the storage view 114A. Also, at least a portion of the non-transactional data 112C was removed from table 106B and stored in the storage view definition 116B of the storage view 114B. In other example embodiments, only a selection of the non-transactional data 112A, 112B, and 112C may be removed from the tables 106A and 106B to be stored in the storage views 114A and 114B, or the non-transactional data 112A, 112B, and 112C may exist in both the storage views 114A and 114B and the tables 106A and 106B.

The table 106B was replaced with the storage view 114B in the database 102B. Then for example, the view 118 associated with the table 106B in the database 102A may be associated with the storage view 114B in the database 102B, wherein a modification to the storage view definition 116B, modifying the non-transactional data 112C may be reflected in the view 118.

The application 124 may not require any modification or notification concerning the addition of the storage views 114A and 114B and/or the replacement of the table 106B. The application 124 may continue to read data from and write data to the database 102B unaware and unaffected by the non-transactional data 112A, 112B and 112C being transferred into the storage views 114A and 114B.

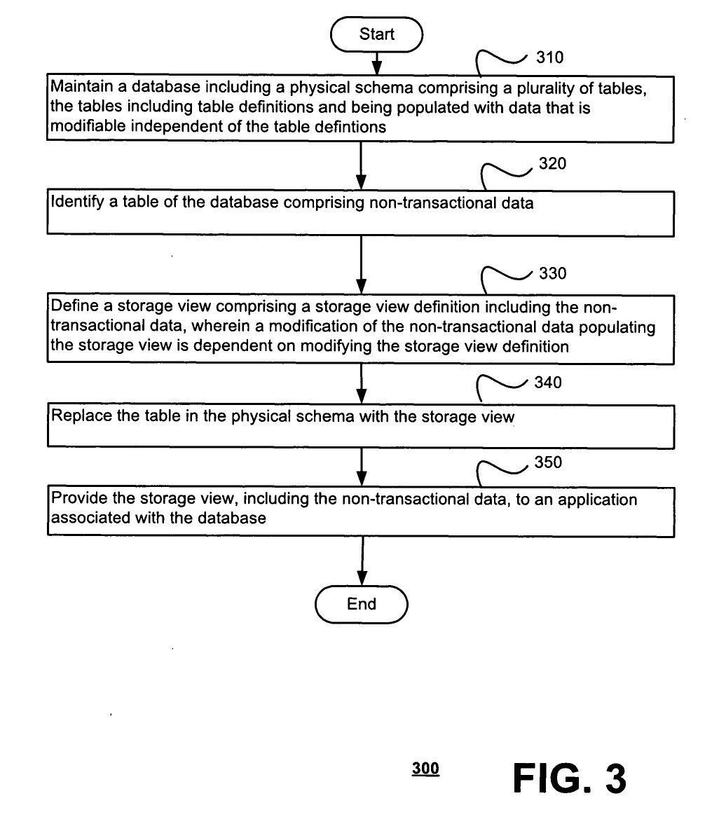

FIG. 3 is a flowchart 300 illustrating example operations of the systems of FIGS. 1 and 2. More specifically, FIG. 3 illustrates an operational flow 300 representing example operations related to the efficient storage and distribution of non-transactional data.

After a start operation, a database including a physical schema including a plurality of tables is maintained, where the tables include table definitions and are populated with data that is modifiable independent of the table definitions (310). For example, the database 102 may include the physical schema 104 including the tables 106A and 106B. The tables 106A and 106B may include transactional data 110A and 110B and non-transactional data 112A that may be modifiable independent of the table definitions 108A and 108B. According to an example embodiment, data of the tables 106A and 106B may be modified using the data manipulation language 122.

A table of the database comprising non-transactional data may be identified (320). For example, the table 106B of the database 102A may be identified to include the non-transactional data 112C.

Then a storage view may be defined, where the storage view includes a storage view definition including the non-transactional data, and where a modification of the non-transactional data populating the storage view is dependent on modifying the storage view definition (330). For example, the storage view 114B may be defined to include the non-transactional data 112C in its storage view definition 116B.

Then the table in the physical schema may be replaced with the storage view (340). For example, the table 106B may be replaced with the storage view 114B. Then for example the view 118 previously associated with the table 106B may become associated with the storage view 114B.

Then the storage view, including the non-transactional data, may be provided to an application associated with the database. For example, the storage view 114B including the non-transactional data 112C may be provided to the application 124.

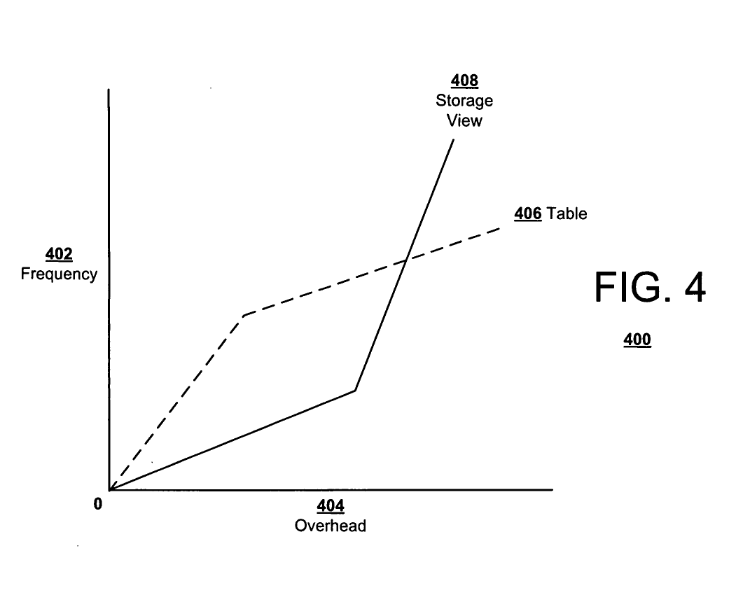

FIG. 4 is a graph 400 illustrating an example of determining whether a storage view or a table should be used to store data. The vertical axis 402 indicates the frequency with which the data is anticipated to be modified, updated, or otherwise changed. The horizontal axis 404 indicates the overhead, including both memory resource overhead and processing overhead, or amount of resources required to create and maintain the data in tables and storage views of a database.

The dashed table line 406 indicates the overhead 404 associated with storing data given the frequency 402 with which the data is anticipated to be updated in the table line 406. The storage view line 408, by contrast, indicates the overhead 404 associated with storing the data given the frequency 402 with which the data is anticipated to be updated in the storage view 408.

For example, the table line 406 may indicate a higher initial overhead than the storage view 408 due to the additional memory resource overhead associated with creating a table. Then for example, as the data is modified more frequently the greater processing overhead associated with a storage view, as discussed above, may cause the storage view line 408 to increase faster than the table line 406.

There may exist for example, an anticipated frequency level wherein the overhead associated with storing data in a storage view versus a table may be exactly the same, at the point where the storage view line 408 and the table line 406 crosses. Then for example, any reduced anticipation in frequency 402 may indicate the storage view 408 to be a more efficient database object to use, while any increased anticipation in frequency 402 may indicate the table 406 to be more efficient.

Implementations of the various techniques described herein may be implemented in digital electronic circuitry, or in computer hardware, firmware, software, or in combinations of them. Implementations may be implemented as a computer program product, i.e., a computer program tangibly embodied in an information carrier, e.g., in a machine-readable storage device or in a propagated signal, for execution by, or to control the operation of, data processing apparatus, e.g., a programmable processor, a computer, or multiple computers. A computer program, such as the computer program(s) described above, can be written in any form of programming language, including compiled or interpreted languages, and can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps may be performed by one or more programmable processors executing a computer program to perform functions by operating on input data and generating output. Method steps also may be performed by, and an apparatus may be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. Elements of a computer may include at least one processor for executing instructions and one or more memory devices for storing instructions and data. Generally, a computer also may include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory may be supplemented by, or incorporated in special purpose logic circuitry.

To provide for interaction with a user, implementations may be implemented on a computer having a display device, e.g., a cathode ray tube (CRT) or liquid crystal display (LCD) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Implementations may be implemented in a computing system that includes a back-end component, e.g., as a data server, or that includes a middleware component, e.g., an application server, or that includes a front-end component, e.g., a client computer having a graphical user interface or a Web browser through which a user can interact with an implementation, or any combination of such back-end, middleware, or front-end components. Components may be interconnected by any form or medium of digital data communication, e.g., a communication network. Examples of communication networks include a local area network (LAN) and a wide area network (WAN), e.g., the Internet.

While certain features of the described implementations have been illustrated as described herein, many modifications, substitutions, changes and equivalents will now occur to those skilled in the art. It is, therefore, to be understood that the appended claims are intended to cover all such modifications and changes as fall within the true spirit of the embodiments.

What is claimed is:

1. A method comprising:
maintaining a database including a physical schema comprising a plurality of tables, the tables including table definitions and being populated with data that is modifiable independent of the table definitions;
identifying a table of the database comprising non-transactional data;
defining a storage view of at least a subset of non-transactional data of the identified table, the storage view comprising a storage view definition including the non-transactional data, wherein a modification of the non-transactional data populating the storage view is dependent on modifying the storage view definition; and
replacing the table in the physical schema with the storage view.

2. The method of claim 1 wherein the database comprises a relational database.

3. The method of claim 1 wherein the physical schema comprises a data model of how the data is to be represented in the database.

4. The method of claim 1 wherein the physical schema comprises the data stored in the database.

5. The method of claim 1 wherein the plurality of tables include tables having data organized into a definite number of columns and a variable number of rows.

6. The method of claim 1 wherein the table-definitions include types of data or descriptions of data included in the tables.

7. The method of claim 1 wherein the data includes transactional data and non-transactional data.

8. The method of claim 1 wherein the identifying the table comprises:
determining a first overhead associated with maintaining and defining a test storage view including test data over a period of time;
determining a second overhead associated with maintaining and modifying a test table including the test data over the period of time;
determining a frequency associated with a number of times the test data may be modified in the test storage view and the test table over the period of time, wherein the first overhead is less than or equal to the second overhead; and
identifying the table of the database comprising the non-transactional data, wherein the non-transactional data is associated with an anticipated number of modifications less than or equal to the frequency.

9. The method of claim 1 wherein replacing the table comprises:
generating a view associated with the table; and
associating the view with the storage view.

10. The method of claim 1 wherein defining the storage view comprises:
copying the non-transactional data from the table into the storage view, wherein the view-definition includes the non-transactional data; and
removing the table from the database.

11. The method of claim 1 further comprising:
determining a modification associated with the non-transactional data in the storage view; and
redefining the view-definition to include the non-transactional data as modified based on the modification.

12. A system comprising:
a computer-readable storage medium adapted for storing:
table data populating a table based on a table definition, wherein the table data can be modified independently of the table definition; and
a storage view comprising a storage view definition including a selection of the data extracted from the table, wherein the selection of data, as stored in the storage view, is modifiable independently of the table data, wherein upon a modification of the table data the storage view data and the table definition remains unchanged and wherein a modification to the storage view requires a modification to the storage view definition; and
a database processor configured to provide the selection of data to via the storage view to a client of the system.

13. The system of claim 12 wherein the data includes non-transactional data anticipated to remain constant.

14. The system of claim 12 wherein the database processor is configured to prevent the client from modifying the storage view definition.

15. The system of claim 12 wherein the table definition includes a plurality of columns, wherein each column is associated with a column name and a data type corresponding to data stored in the table.

16. The system of claim 12 wherein the extracted selection of data is removed from the table.

17. The system of claim 12 wherein the table is removed after the data is extracted.

18. A system comprising:
a computer-readable storage medium adapted for storing a database, the database comprising:
tables of transactional data including table definitions, wherein the transactional data is modifiable independent of the table definitions;
storage views of non-transactional data including storage view definitions, wherein a modification of the non-transactional data requires a modification of a view definition;
a processor adapted for executing an application to read data from the tables and the storage views and to write data to the tables;
a comparator configured to determine that data provided by the application, to be written to the database, includes non-transactional data to be stored in a first storage view; and
a database processor configured to define the first storage view to include the data provided by the application in the view definition associated with the first storage view.

19. The system of claim 18 wherein the database comprises:
a view associated with one or more of the tables, wherein a modification of the transactional data in the one or more tables modifies the transactional data as represented in the view.

20. The system of claim 18 wherein one or more of the tables include non-transactional data.
